(19) United States
(12) Patent Application Publication
(10) Pub. No.: US 2024/0398657 A1
(43) Pub. Date: Dec. 5, 2024

(54) Non-contact driven air wave massage device

(71) Applicant: Mylovey Limited, Shenzhen (CN)

(72) Inventor: Huiming ZHONG, Shenzhen (CN)

(21) Appl. No.: 18/502,700

(22) Filed: Nov. 6, 2023

(30) Foreign Application Priority Data
May 31, 2023 (CN) 2023106393056

(51) Int. Cl. A61H 9/00

(52) U.S. Cl. CPC A61H 9/0071; A61H 2201/0111; A61H 2201/123

(57) ABSTRACT

A non-contact driven air wave massage device includes a housing; at least one chamber provided with at least one opening leading to outside the device and at least one motion chamber; a magnetic sliding portion slidingly provided inside the motion chamber and having at least one magnet or at least one component made of a magnetic attractive substance; a driving mechanism located outside the chamber and fixedly connected to the housing; and a power source electrically connected to a control unit. The control unit controls the driving mechanism to apply electromagnetic forces or magnetic forces in a non-contact manner to the magnetic sliding portion, to cause the magnetic sliding portion to reciprocate within the motion chamber and generate air waves at the opening.

### TECHNICAL FIELD

The present invention relates to a massage device, in particular to an air wave massage device.

### BACKGROUND TECHNOLOGY

With the increasing pace of work and life, people are more liable to experience physical and mental fatigue. Manual massage or the use of therapeutic massage devices to massage specific body parts can greatly benefit by promoting blood circulation and relaxing muscles. It can also help to ease stress, relax the mind, and provide therapeutic and healthcare effects. To meet needs, various types of massage devices have emerged. However, most existing massage devices are directly driven, and often have poor waterproofing performance. Therefore, issues with the operation of the driving mechanism are caused frequently due to water-related problems.

### SUMMARY OF THE INVENTION

The present invention aims to provide a non-contact driven air wave massage device with good water resistance.

Purposes of the present invention can be achieved by providing following technical solutions:

A non-contact driven air wave massage device, comprises

a housing,

at least one chamber, wherein the at least one chamber is provided with at least one opening leading to outside the device and at least one motion chamber;

a magnetic sliding portion basically substantially sealed and slidingly provided inside the at least one motion chamber, wherein the magnetic sliding portion comprises at least one magnet or at least one component made of a magnetic attractive substance;

a driving mechanism located outside the at least one chamber and fixedly connected to the housing, wherein the driving mechanism comprises at least one electromagnetic coil or/and at least one magnet provided along a radial direction of the at least one motion chamber and spaced apart from the magnetic sliding portion; and

a power source electrically connected to a control unit, wherein

the control unit controls the driving mechanism to apply electromagnetic forces or magnetic forces to the magnetic sliding portion without contact, so as to cause the magnetic sliding portion to reciprocate within the at least one motion chamber and generate air waves at the at least one opening.

Further, the non-contact driven air wave massage device comprises waterproof barrier walls, wherein the waterproof barrier walls are fixedly connected to the housing or formed by a part of the housing; the at least one chamber is provided on a side of the waterproof barrier walls; and a driving mechanism is provided on another side of the waterproof barrier walls.

Further, the at least one chamber is at least partially located inside space enclosed by the waterproof barrier walls; and the driving mechanism is provided inside the housing.

Further, the driving mechanism comprises at least one electromagnetic coil placed around outer walls of the at least one motion chamber, and the at least one electromagnetic coil is electrically connected to the control unit.

Further, the at least one electromagnetic coil is provided on outer walls of the waterproof barrier walls and parallel to inner walls of the at least one motion chamber.

Further, the driving mechanism comprises at least one magnet and an electric device, an output end of the electric device is connected to the at least one magnet, the at least one magnet is correspondingly provided along a radial direction of the at least one motion chamber and spaced apart from the magnetic sliding portion, and the electric device drives the at least one magnet which drives the magnetic sliding portion to move through magnetic forces.

Further, the driving mechanism comprises at least one magnet, an electric device, and a connecting piece, an output end of the electric device is connected to the connecting piece, and the at least one magnet is fixed on the connecting piece; and

the at least one magnet is correspondingly provided and spaced apart from the magnetic sliding portion along a radial direction of the at least one motion chamber;

the at least one magnet is connected to the magnetic sliding portion through magnetic attraction; the electric device, through the connecting piece, drives the at least one magnet to make a longitudinal reciprocating motion towards an outer wall of the at least one motion chamber, causing the at least one magnet, through magnetic forces, to drive the magnetic sliding portion to make a longitudinal reciprocating motion within the at least one motion chamber.

Further, the magnetic sliding portion comprises a permanent magnet, an N pole and an S pole of the permanent magnet are provided in a radial direction of the at least one motion chamber; and

two magnets are respectively provided on the connecting piece and attract the permanent magnet in a direction close to an outer wall of the at least one motion chamber.

Further, the connecting piece is cylindrical and movably sleeved on an outer wall of the at least one chamber.

Further, the at least one chamber is provided with at least one air hole, and the at least one air hole is communicated with the at least one motion chamber.

Further, vent gaps or vent slots are provided between outer walls of the at least one chamber and the waterproof barrier walls, and the vent gaps or the vent slots are communicated with the at least one air hole, and the vent gaps or vent slots are communicated with outer portions of the housing.

Further, the at least one chamber is substantially cylinder-shaped and space enclosed by the waterproof barrier walls is substantially cylinder-shaped.

Further, a cross-sectional area S1 of the at least one opening is equal to or less than a cross-sectional area S2 of the at least one motion chamber.

Further, a largest portion at a cross section of the magnetic sliding portion is circular.

Further, parallel lines of inner walls of the at least one motion chamber are perpendicular to a radial section of the at least one motion chamber.

Further, the at least one motion chamber is provided with limiting portions at two ends of a moving path of the magnetic sliding portion.

Further, the magnetic sliding portion is provided with sealing rings.

The present invention generates air waves through a non-contact driving mode, greatly improves waterproof performance of the device, and expands the application scenario.

### BRIEF DESCRIPTION OF THE DRAWINGS

FIG. 1 is a schematic diagram of a first preferable embodiment of the present invention.

FIG. 2 is a schematic diagram of a part A of FIG. 1.

FIG. 3 is a schematic diagram of a second preferable embodiment of the present invention.

FIG. 4 is a schematic diagram of a third preferable embodiment of the present invention.

FIG. 5 is a schematic diagram of a fourth preferable embodiment of the present invention.

FIG. 6 is a schematic diagram of a fifth preferable embodiment of the present invention.

FIG. 7 is a schematic diagram of a sixth preferable embodiment of the present invention

FIG. 8 is a schematic diagram of a seventh preferable embodiment of the present invention.

FIG. 9 is a schematic diagram of an eighth preferable embodiment of the present invention.

FIG. 10 is a schematic cross-sectional view of a tubular connecting piece according to a preferable embodiment of the present invention.

### SPECIFIC EMBODIMENTS

The present invention is further described in conjunction with embodiments below.

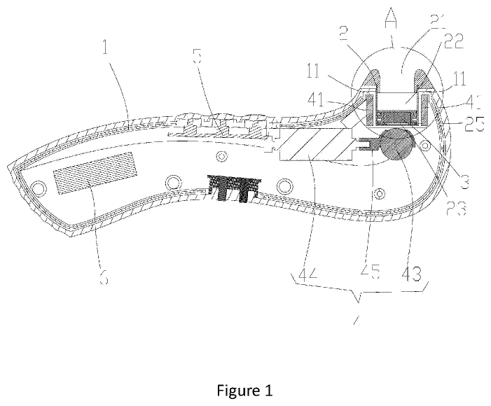

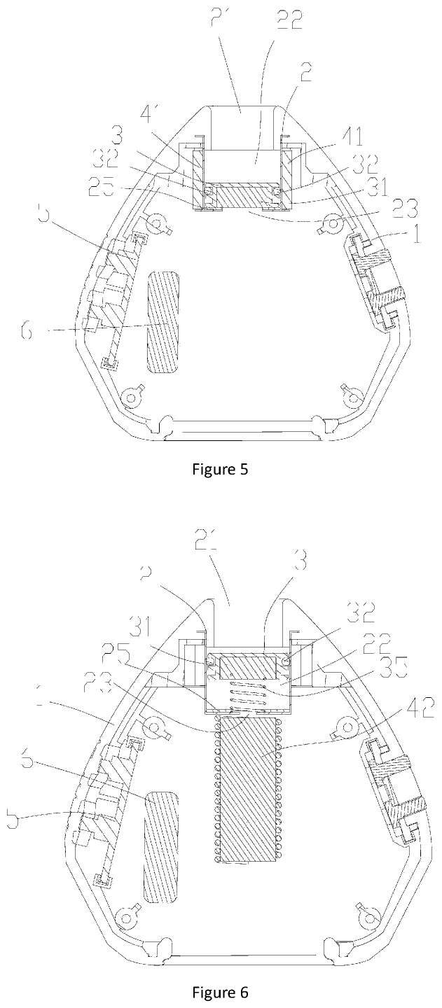

As shown in FIGS. 1, 2, 3, 4 and 5, a non-contact driven air wave massage device, comprising a housing 1, at least one chamber 2, a magnetic sliding portion 3, a driving mechanism 4, a control unit 5 and a power source 6.

The housing 1 is provided with the at least one chamber 2, the at least one chamber 2 is provided with at least one opening 21 and at least one motion chamber 22; the magnetic sliding portion 3 is substantially sealed and slidingly provided inside the at least one motion chamber 22 and comprises at least one magnet or at least one component made of a magnetic attractive substance; the driving mechanism 4 located outside the at least one chamber 2 and fixedly connected to the housing, comprises at least one electromagnetic coil or/and at least one magnet provided along a radial direction of the at least one motion chamber 22 and spaced apart from the magnetic sliding portion 3; and the power source 6 is electrically connected to the control unit 5 and supplies the control unit 5 with power.

The control unit 5 controls the driving mechanism 4 to apply electromagnetic forces or magnetic forces in a non-contact manner to the magnetic sliding portion 3, so as to make the magnetic sliding portion 3 reciprocate within the at least one motion chamber 22. The magnetic sliding portion 3 reciprocates and drives air flow to change in the at least one chamber 2, to generate air waves at the at least one opening 21.

The present invention further comprises waterproof barrier walls 11, wherein the waterproof barrier walls 11 are fixedly connected to the housing 1 or formed by a part of the housing 1; the at least one chamber 2 is provided on a side of the waterproof barrier walls 11; and a driving mechanism 4 is provided on another side of the waterproof barrier walls 11; and arrangement of waterproof barrier walls 11 greatly improves water resistance of the massage device.

The at least one chamber 2 is at least partially located inside space enclosed by the waterproof barrier walls 11; and the driving mechanism 4 is provided inside the housing 1.

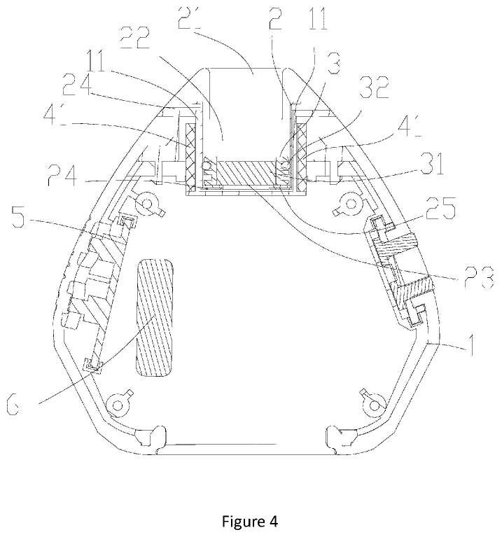

In an embodiment, as shown in FIG. 4, the driving mechanism 4 comprises at least one electromagnetic coil 41 placed around outer walls of the at least one motion chamber 22, and the at least one electromagnetic coil 41 is electrically connected to the control unit 5. The at least one electromagnetic coil 41 is provided on outer walls of the waterproof barrier walls 11 and parallel to inner walls of the at least one motion chamber 22. In the present embodiment, the control unit 5 energizes the at least one electromagnetic coil 41 and drives the magnetic sliding portion 3 through the at least one electromagnetic coil 41.

In an embodiment, the driving mechanism 4 comprises at least one electromagnet 42, and is electrically connected to the control unit 5; the at least one electromagnet 42 is correspondingly provided and spaced apart from the magnetic sliding portion 3 along a longitudinal direction of the at least one motion chamber 22; and in the present embodiment, the at least one electromagnet 42 drives the magnetic sliding portion 3 by switching polarity.

Also, as shown in FIG. 6, below the magnetic sliding portion 3 is provided a spring 35, the magnetic sliding portion 3 could comprise a permanent magnet 31 or an iron block, so that the magnetic sliding portion 3 is driven by start and release of the electromagnet 42.

In an embodiment, the driving mechanism 4 comprises at least one magnet 43 and an electric device 44, an output end of the electric device 44 is connected to the at least one magnet 43, the at least one magnet 43 is correspondingly provided and spaced apart from the magnetic sliding portion 3 along a radial direction of the at least one motion chamber 22, and the electric device 44 drives the at least one magnet 43 which drives the magnetic sliding portion 3 to move through magnetic forces.

In an embodiment, as shown in FIG. 1, the driving mechanism 4 comprises at least one magnet 43, an electric device 44, and a connecting piece 45, an output end of the electric device 44 is connected to the connecting piece 45, and the at least one magnet 43 is fixed on the connecting piece 45; the at least one magnet 43 is correspondingly provided and spaced apart from the magnetic sliding portion 3 along a longitudinal direction of the at least one motion chamber 22; the electric device 44 drives an angle of the at least one magnet to change through the connecting piece 45, so that an N pole and an S pole of the at least one magnet 43 alternately correspond to the magnetic sliding portion 3. When polarities of the permanent magnet 31 of the magnetic sliding portion and an opposite end thereof remains unchanged, the at least one magnet 43 alternately corresponds to the N pole and the S pole, and magnetic forces are utilized to drive the magnetic sliding portion 3 to reciprocate longitudinally in the at least one motion chamber 22.

In an embodiment, as shown in FIG. 3, the driving mechanism 4 comprises at least one magnet 43, an electric device 44, and a connecting piece 45, an output end of the electric device 44 is connected to the connecting piece 45, the magnet 43 is fixed on the connecting piece 45, the magnet 43 is correspondingly provided on and spaced apart from the magnetic sliding portion 3 along the radial direction of the at least one motion chamber 22; the at least one magnet 43 is connected to the magnetic sliding portion 3 through magnetic attraction; the electric device 44, through the connecting piece 45, drives the at least one magnet 43 to reciprocate longitudinally towards an outer wall of the at least one motion chamber 22, causing the at least one magnet 43 to drive the magnetic sliding portion 3 through magnetic forces to reciprocate longitudinally within the at least one motion chamber 22.

As shown in FIG. 3 and FIG. 8, the magnetic sliding portion 3 comprises a permanent magnet 31, N and S poles of the permanent magnet 31 are provided in a radial direction of the at least one motion chamber 22; two magnets are respectively provided on the connecting piece 5 and attract the permanent magnet 31 in a direction close to an outer wall of the at least one motion chamber 22.

As shown in FIG. 10, the connecting piece 45 is cylindrical and movably sleeved on on an outer wall of the at least one chamber 2.

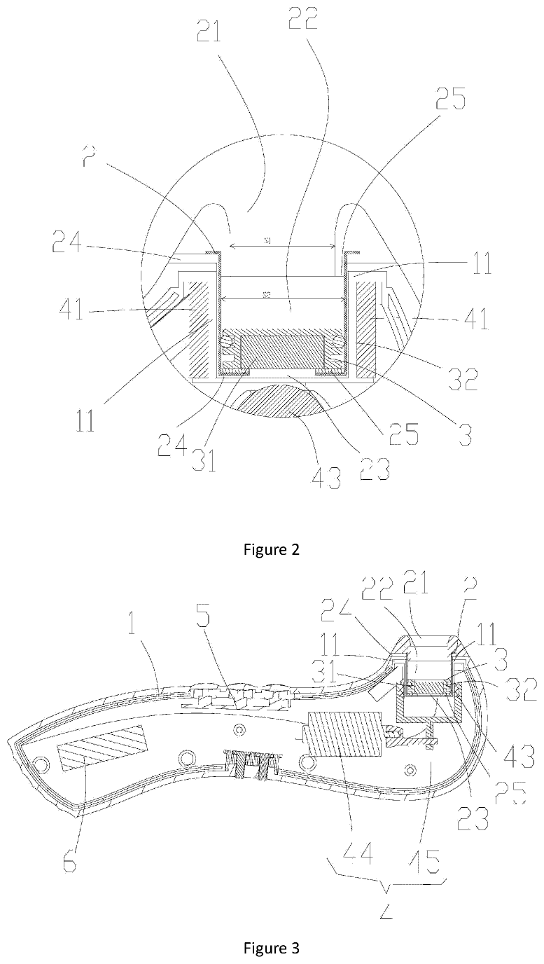

As shown in FIG. 2, the at least one chamber 2 is provided with at least one air hole 23, and the at least one air hole 23 is communicated with the at least one motion chamber 22, and the at least one air hole 23 is provided to reduce running resistance of the magnetic sliding portion 3.

As shown in FIG. 2 and FIG. 4, vent gaps or vent slots 24 are provided between outer walls of the at least one chamber 2 and the waterproof barrier walls 11, and the vent gaps or the vent slots 24 are communicated with the at least one air hole 23, and the vent gaps or vent slots 24 are communicated with outer portions of the housing 1.

In an embodiment, as shown in FIG. 8, a driving power portion comprises a linear motor which includes a stator 46 and an actuator 47, one end of the connecting piece 45 is fixed on the actuator 47, and the at least one magnet 43 is driven by the linear motor near an outer wall of the at least one motion chamber 22 to reciprocate longitudinally.

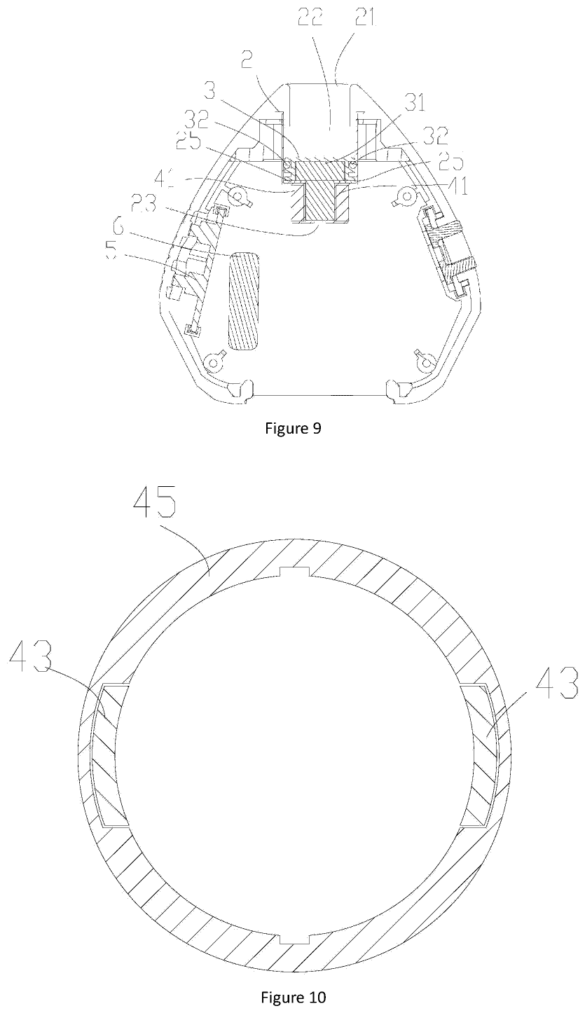

In an embodiment, as shown in FIG. 9, the permanent magnet 31 of the magnetic sliding portion 3 is T-shaped, a bottom portion of the at least one chamber 2 is provided with a through slot to engage with the permanent magnet 31, the at least one electromagnetic coil 41 is arranged on an outer wall of the through slot, and the at least one electromagnetic coil 41 drives the T-shaped permanent magnet to reciprocate.

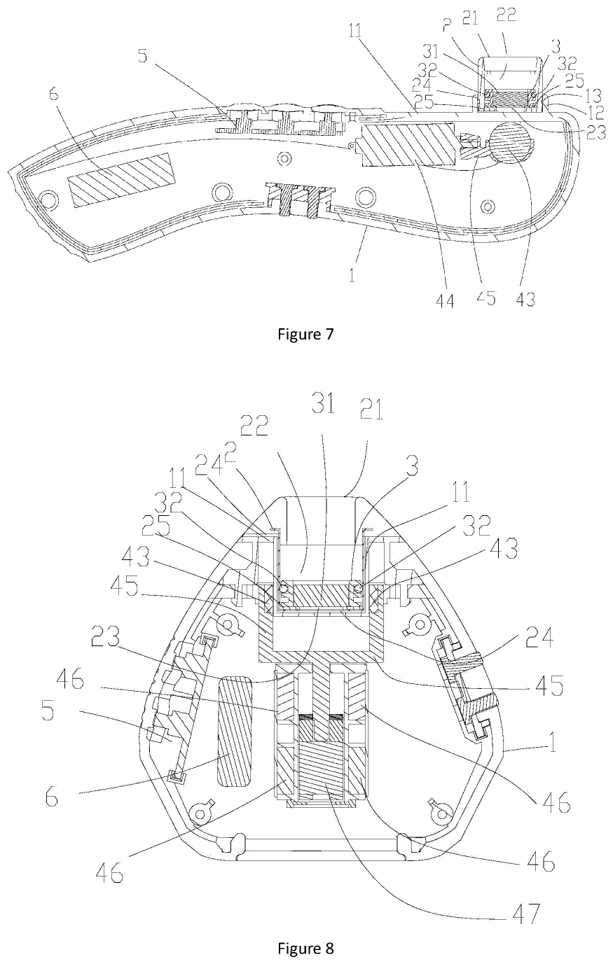

The at least one chamber 2 can also be arranged on an outer surface of the housing 1. As shown in FIG. 7, a slot 12 is provided on the housing 1, and the at least one chamber 2 is placed on the slot 12. In the present embodiment, the at least one chamber 2 is secured by latching protrusions 13, so that it is difficult for the at least one chamber 2 to fall off. The driving mechanism 4 is installed in the housing 1. This design allows easy replacement of the at least one chamber 2, making massage more hygienic.

The at least one chamber 2 is substantially cylinder-shaped, and space enclosed by the waterproof barrier walls 11 is substantially cylinder-shaped.

As shown in FIG. 2, a cross-sectional area S1 of the at least one opening 21 is equal to or less than a cross-sectional area S2 of the at least one motion chamber 22.

A largest portion at a cross section of the magnetic sliding portion 3 is circular.

Parallel lines of inner walls of the at least one motion chamber 22 are perpendicular to a radial section of the at least one motion chamber 22.

As shown in FIG. 2, the at least one motion chamber 22 is provided with limiting portions 25 at two ends of a moving path of the magnetic sliding portion 3. The limiting portions 25 are made of soft materials.

The magnetic sliding portion 3 is provided with sealing rings 32. The sealing rings 32 form sealing effect between the magnetic sliding portion 3 and the at least one motion chamber 22, so that movement of the magnetic sliding part 3 pushes air in the at least one motion chamber 22 to form more concentrated air flows.

The power source 6 can be a battery or an access port of an external power source.

The present invention generates air waves in a non-contact driving manner, which greatly improves waterproof performance of the device and expands the use scenarios.

The above-mentioned embodiments are only some preferred embodiments of the present invention and do not limit protection scope of the present invention. For those skilled in the art, equivalent substitutions can still be made to the technical solutions described in the above specific embodiments. All equivalent technical solutions made using the content of the present invention are within the protection scope of the present invention.

1. A non-contact driven air wave massage device, comprising: a housing,
at least one chamber, wherein the at least one chamber is provided with at least one opening leading to outside the device and at least one motion chamber;
a magnetic sliding portion substantially sealed and slidingly provided inside the at least one motion chamber, wherein the magnetic sliding portion comprises at least one magnet or at least one component made of a magnetic attractive substance;
a driving mechanism located outside the at least one chamber and fixedly connected to the housing, wherein the driving mechanism comprises at least one electromagnetic coil or/and at least one magnet provided along a radial direction of the at least one motion chamber and spaced apart from the magnetic sliding portion; and
a power source electrically connected to a control unit, wherein the control unit controls the driving mechanism to apply electromagnetic forces or magnetic forces to the magnetic sliding portion without contact, so as to cause the magnetic sliding portion to reciprocate within the at least one motion chamber and generate air waves at the at least one opening.

2. The non-contact driven air wave massage device according to claim 1, comprising waterproof barrier walls, wherein the waterproof barrier walls are fixedly connected to the housing or formed by a part of the housing; the at least one chamber is provided on a side of the waterproof barrier walls; and a driving mechanism is provided on another side of the waterproof barrier walls.

3. The non-contact driven air wave massage device according to claim 1, wherein the at least one chamber is at least partially located inside space enclosed by the waterproof barrier walls; and the driving mechanism is provided inside the housing.

4. The non-contact driven air wave massage device according to claim 1, wherein the driving mechanism comprises at least one electromagnetic coil, the at least one electromagnetic coil is placed around outer walls of the at least one motion chamber, and the at least one electromagnetic coil is electrically connected to the control unit.

5. The non-contact driven air wave massage device according to claim 4, wherein the at least one electromagnetic coil is provided on outer walls of the waterproof barrier walls and parallel to inner walls of the at least one motion chamber.

6. (canceled)

7. The non-contact driven air wave massage device according to claim 1, wherein the driving mechanism comprises at least one magnet and an electric device, an output end of the electric device is connected to the at least one magnet, the at least one magnet is correspondingly provided along a radial direction of the at least one motion chamber and spaced apart from the magnetic sliding portion, and the electric device drives the at least one magnet which drives the magnetic sliding portion to move through magnetic forces.

8. (canceled)

9. The non-contact driven air wave massage device according to claim 1, wherein the driving mechanism comprises at least one magnet, an electric device, and a connecting piece, an output end of the electric device is connected to the connecting piece, the at least one magnet is fixed on the connecting piece; the at least one magnet is correspondingly provided along a radial direction of the at least one motion chamber and spaced apart from the magnetic sliding portion;
the at least one magnet is connected to the magnetic sliding portion through magnetic attraction; and the electric device, through the connecting piece, drives the at least one magnet to make a longitudinal reciprocating motion towards an outer wall of the at least one motion chamber, causing the at least one magnet to drive the magnetic sliding portion through magnetic forces to make longitudinal reciprocating motion within the at least one motion chamber.

10. The non-contact driven air wave massage device according to claim 7, wherein the magnetic sliding portion comprises a permanent magnet, an N pole and an S pole of the permanent magnet are provided in a radial direction of the at least one motion chamber; and
two magnets are respectively provided on the connecting piece and attract permanent magnet in a direction close to an outer wall of the at least one motion chamber.

11. The non-contact driven air wave massage device according to claim 8, wherein the connecting piece is cylindrical and movably sleeved on an outer wall of the at least one chamber.

12. The non-contact driven air wave massage device according to claim 1, wherein the at least one chamber is provided with at least one air hole, and the at least one air hole is communicated with the at least one motion chamber.

13. The non-contact driven air wave massage device according to claim 10, wherein vent gaps or vent slots are provided between outer walls of the at least one chamber and the waterproof barrier walls, and the vent gaps or the vent slots are communicated with the at least one air hole, and the vent gaps or vent slots are communicated with outer portions of the housing.

14. The non-contact driven air wave massage device according to claim 1, wherein the at least one chamber is substantially cylinder-shaped and space enclosed by the waterproof isolation walls is substantially cylinder-shaped.

15. The non-contact driven air wave massage device according to claim 1, wherein a cross-sectional area S1 of the at least one opening is equal to or less than a cross-sectional area S2 of the at least one motion chamber.

16. The non-contact driven air wave massage device according to claim 1, wherein a largest portion of a cross section of the magnetic sliding portion is circular.

17. The non-contact driven air wave massage device according to claim 1, wherein parallel lines of inner walls of the at least one motion chamber are perpendicular to a radial section of the at least one motion chamber.

18. The non-contact driven air wave massage device according to claim 1, wherein the at least one motion chamber is provided with limiting portions at two ends of a moving path of the magnetic sliding portion.

19. The non-contact driven air wave massage device according to claim 1, wherein the magnetic sliding portion is provided with sealing rings.
